(19) United States
(12) Patent Application Publication
(10) Pub. No.: US 2015/0213550 A1
(43) Pub. Date: Jul. 30, 2015

(54) METHOD, SYSTEM, SERVICE, AND COMPUTER PROGRAM PRODUCT FOR VERIFICATION AND DELIVERY OF EMPLOYMENT AND INCOME INFORMATION

(71) Applicant: PointServ, Inc., Burlingame, CA (US)

(72) Inventors: Iavor BOYANOV, Burlingame, CA (US); Iordan GAVAZOV, San Carlos, CA (US)

(21) Appl. No.: 14/678,659

(22) Filed: Apr. 3, 2015

Related U.S. Application Data
(63) Continuation of application No. 14/150,581, filed on Jan. 8, 2014, now abandoned.
Application No. 14/150,581 is a continuation-in-part of application No. 14/103,455, filed on Dec. 11, 2013.
(60) Provisional application No. 61/865,446, filed on Aug. 13, 2013.

(51) Int. Cl. G06Q 40/02; G06Q 10/10

(52) U.S. Cl. CPC G06Q 40/025; G06Q 10/10

(57) ABSTRACT

A technique of employment and income verification for making a lending decision is disclosed that does not require requesting manual employment and income verification and performing a manual comparison of the results of such verification to payroll documents provided by the borrower. The borrower provides authentication information (e.g., login credentials), which a verification service utilizes to obtain the borrower's employment and income information from a payroll provider. The verification service delivers verified employment and income data and payroll documents to the lender, which can be provided securely in a tamper proof form. Techniques to provide privacy protection for the borrower may include a privacy protection protocol. Additionally, a certificate of authenticity may be provided to the lender.

### CROSS-REFERENCE TO RELATED APPLICATIONS

This application is a continuation of U.S. patent application Ser. No. 14/150,581, filed on Jan. 8, 2014, which is a continuation-in-part of U.S. patent application Ser. No. 14/103,455, filed on Dec. 11, 2013, which claims the benefit of priority under U.S.C. §119(e) to U.S. Provisional Patent Application No. 61/865,446, filed on Aug. 13, 2013, which are incorporated herein by reference in their entirety for all purposes.

### BACKGROUND OF THE INVENTION

1. The Field of the Invention

The invention relates to a process for confirming the authenticity of pay stubs, earnings statements, federal W-2 Wage and Tax Statements, earnings summaries and other similar documents (collectively “Payroll Documents”; and “Payroll Document” means any of them) by obtaining the payroll document, and information about it, from trustable sources such as payroll software providers (“Payroll Providers”). Payroll Providers are companies that offer computer programs that an employee can use to access their payroll documents electronically. Many of these providers offer their software as a service through a website accessible over the Internet.

2. Existing Process Used Throughout the U.S. Mortgage Industry to Verify Employment and Income Information

In applying for a loan (e.g., home mortgage), a borrower is required to fill out various forms for the lender, and also provide evidence of the borrower's ability to pay back the loan. This includes providing proof of the borrower's income and employment. One form of information that is normally required of the borrower is a copy of the borrower's payroll documents in order to perform a check of the borrower's employment and income.

However, payroll documents provided by a borrower could be incorrect or falsified. To provide a safeguard against potential mortgage fraud, it is an industry-wide practice to also verify the payroll document. For example, companies such as Veri-Tax, LLC of Irvine Calif., offer verification of employment, typically within about 48 hours. This time delay is associated with both the time required for the verification service to obtain the information from the employer and any additional time required by the verification service to perform additional manual checking.

This verification process follows a de facto industry standard in that it is the practice of major government backed lending programs (Fannie Mae and Freddie Mac programs), and also major banks and other lending institutions. In particular, in the prior art, the borrower is required to execute an authorization form (authorizing the lender to request information from the borrower's employer), and then a contact is made with the appropriate employer to verify the information contained within the payroll document. However, this industry standard process is very inefficient.

FIG. 1 sets forth the prior art process. Currently, any person or an institution interested in obtaining a verified copy of a payroll document (“Interested Party”) of another person must follow a tedious and time consuming process to do so (FIG. 1). The prior art process includes multiple steps that must be performed by a borrower 105, a lender 110, a third party vendor 115, and the employer 120. We now discuss the major steps from the standpoint of an interested party (typically the lender or someone associated with the lending process).

First, the interested party must obtain a copy of the payroll document from the borrower. That step in itself could be difficult and time consuming in some instances as the borrower must first locate a copy of the payroll document, and then submit it to the interested party.

As a second step, the interested party must obtain consent from the borrower that authorizes the appropriate employer to release data about the payroll document to the interested party. For example, to authorize an employer to release information about an earnings statement for a prospective borrower, the borrower will be required by the lender to sign a “Borrower's Certification and Authorization Form.”

The next step in the process would be for the interested party to contact and request the necessary data from the employer. This can be done directly, but in most cases, it is done through a third party vendor company that specializes in processing such requests. This step may take many days to complete, for example, in the case of obtaining employment information, the typical turnaround time is two business days. Additionally, employers have strict cutoff times, which can mean that if a prospective borrower begins the paperwork before a holiday weekend, the information may not arrive for many days.

Finally, once data is returned back from the employer, the interested party must spend time and resources to reconcile that data to the payroll document provided by the borrower in order to ensure its authenticity. This manual step can also be performed, in some cases, by a third party vendor.

Now consider the steps from the standpoint of a legitimate borrower. The legitimate borrow has to find their payroll document and provide a copy to the interested party. This itself can be a burden if the user is providing a hardcopy, as the user must find and copy the payroll document. If a softcopy is provided by email, the borrower's confidential information might be compromised. Additionally, the borrower must execute and sign the authorization form and return either a hardcopy or a softcopy of the signed form. Additionally, the legitimate borrower may be in a hurry to go house hunting. The fact that the traditional process takes several days to complete can be frustrating to a legitimate borrower with a tight schedule.

Thus, the existing process is very tedious and time consuming as it requires manual actions from each party involved—the borrower must look for a copy of the payroll document, and must find a way to submit it to the interested party, the interested party or its third party representative must obtain and validate the borrower's consent form, the employer must validate and process the request for employment information, and finally the interested party must reconcile the employment information against the payroll document provided by the borrower.

Therefore, the present invention was developed to address the drawbacks of the prior art approach.

### SUMMARY OF THE INVENTION

Having a borrower provide payroll documents to verify their employment and income to a mortgage lender suffers from the problem that a borrower might deliberately submit fake, incorrect, or falsified payroll documents. Thus, most lenders do not rely solely on payroll documents submitted by a borrower. Additional anti-fraud measures are required to reduce the risk of mortgage fraud.

The de facto standard in the mortgage loan industry used to verify employment and income of borrowers is inefficient and typically requires several days to complete and requires steps such as requesting employment information from the employer and performing a manual comparison between the employment information and copies of payroll documents provided by a borrower. Additionally, in the prior art a legitimate borrower has the burden of providing copies of their payroll documents, signing and returning the an authorization form, and weighting days for the process to complete. Additionally, there is a potential privacy concerns for a legitimate borrower.

To overcome these limitations, it is therefore an object of the present invention to provide a fast, convenient process to obtain a verified copy of employment and income information, which may include a verified copy of a payroll document and/or a verified summary of relevant payroll document information, such as an employment and income verification. In accordance with the invention, needless steps from the existing process used in the mortgage loan industry are eliminated and the time required for verifying employment and income information is significantly reduced.

The present invention provides a paradigm shift in the mortgage industry for verifying employment and income. The inventors have recognized that many borrowers receive their payroll documents via a payroll provider service. The records of the payroll provider can be accessed by a trusted verification service and additional layers of checking, security, and tamper proofing can be provided in order to deliver verified employment and income information to a lender. To achieve the objects of the invention, in one embodiment, there is provided a method for a trusted verification service to access a borrower's payroll document information from a payroll provider. The end product is a verified payroll document, meaning a copy of a payroll document that is verified to be authentic by the nature of the source from where it was obtained—i.e., it is based on information retrieved from the payroll provider and thus protects against common forms of fraud seen in the mortgage industry in which a borrower submits falsified payroll documents. Additional security protection can be included, such as providing the payroll document information in a tamper-proof file and using secure communications between the verification service and lender.

Moreover, the present invention provides convenience and privacy protection to legitimate borrowers. The legitimate borrower does not have to submit payroll documents in addition to filing out and submitting an authorization form. The borrower saves time in the loan process. Additionally the legitimate borrower does not have to submit payroll documents via insecure email connections. Features are preferably included to provide a high level of privacy and security for the borrower's confidential information.

An exemplary method comprises the steps of a trusted verification service receiving the borrower's data and consent and obtaining a payroll document directly from a payroll provider over the Internet. The process may be triggered by a request from a lender, resulting in the borrower being provided with a link or a user interface to enter the data and consent. The borrower is not involved in accessing the payroll document such that the borrower is prevented from tampering with and falsifying the payroll document. Additional privacy and security protection may be provided by securely providing the employment and income information to the lender in a tamper-proof file. A certificate of authenticity may also be generated for the lender.

An exemplary system for implementing the method is a computer based system having one or more servers and interfaces. The system may be implemented as a third party service aiding lenders. However, more generally the system may also be implemented by other parties, such as by a payroll provider or by a lender.

### BRIEF DESCRIPTION OF THE DRAWINGS

FIG. 1 provides an example of how the de facto industry standard process works when verifying the authenticity of a payroll document for a mortgage lender in accordance with the prior art.

FIG. 2A illustrates a method for providing employment and income verification in accordance with an embodiment of the present invention.

FIG. 2B illustrates a method for verifying the authenticity of a payroll document in accordance with an embodiment of the present invention.

FIG. 3 compares the process examples outlined in FIG. 1 and FIG. 2B.

FIG. 4 is a system view of the process that takes place when utilizing the present invention, outlining the software modules that are involved in a typical use example in accordance with an embodiment of the present invention.

FIG. 5 illustrates an embodiment of a system in which the system is implemented by a lender in accordance with an embodiment of the present invention.

FIG. 6 illustrates an embodiment of a system in which a system verifies a payroll document received from a lender in accordance with an embodiment of the present invention.

FIG. 7 illustrates an embodiment of a system in which a payroll provider verifies payroll document information in accordance with an embodiment of the present invention.

### DETAILED DESCRIPTION

A fast and convenient computer-implemented process for a trusted verification service to provide a verified copy of a payroll document is disclosed. Additionally, the process can be used to obtain a verified summary of employment and income. The process is applicable to the large percentage of borrowers that directly or indirectly have access to electronic payroll documents.

Many borrowers use a payroll provider website to electronically access their payroll documents. One aspect of the invention is the recognition by the inventors that a large percentage of prospective borrowers have access to electronic payroll documents through payroll providers such as ADP®.

Another aspect of the invention is the recognition that the payroll providers maintain payroll documents for their customers. This information from the payroll providers is thus a potential source of information for many individuals.

Yet another aspect of the invention is the recognition by the inventors that the information stored by payroll providers may be acquired and used to obtain verified employment and income information for prospective borrowers seeking a loan.

The trusted verification service implements the processes via software modules running on a computer system having at least one processor and a memory, as well as any necessary database systems, security mechanisms, servers, and interfaces. The software modules may, in turn, be stored or sold as computer instructions stored on a non-transitory computer readable medium.

Trust is an important part of the verification. The lender needs to trust that the information is valid and not tampered with. Additionally, borrowers need to have trust that their private information is secure. Depending on implementation, additional server support, including web servers, may be provided to access information over the Internet and maintain privacy and security of employment and income records. To support privacy and tamper-proofing, software and hardware to support privacy and security are also preferably included. Additional trust measures, such as generating certificates of authenticity, may also be employed.

No prior art manual processes exist that are comparable to the present invention. The present invention describes a new paradigm for the mortgage loan industry. Consequently, it will be understood that a computer system implementing any of the methods of the present invention functions as a specially programmed (special purpose) computer.

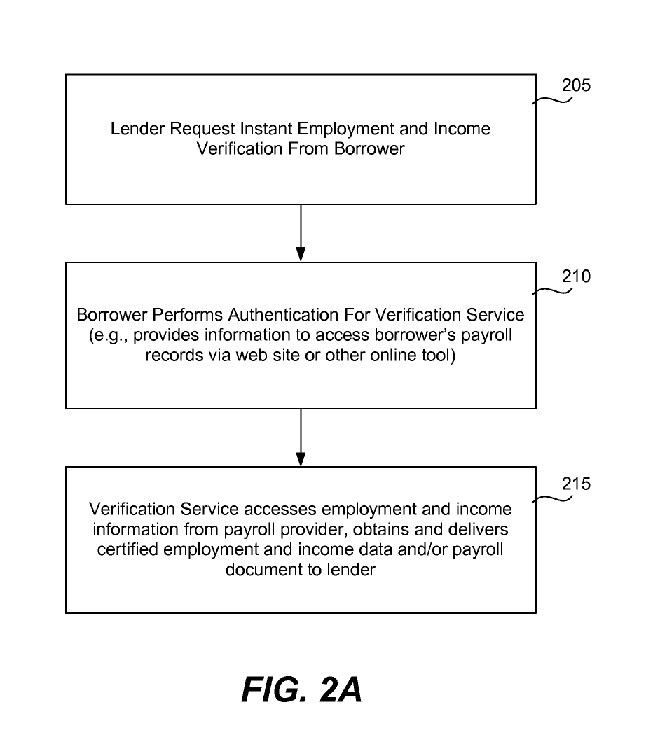

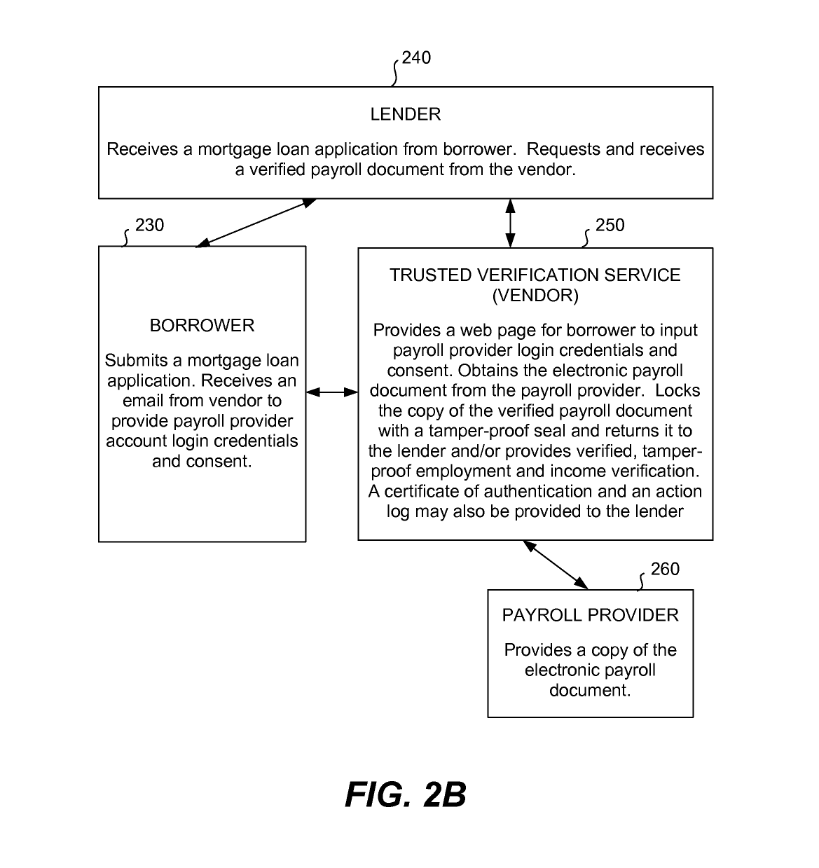

FIG. 2A illustrates a sequence of actions between a lender, a borrower, and a service provider in accordance with an embodiment of the present invention. A lender requests employment and income verification from a borrower (step 205). The borrower then performs an authentication step for the trusted verification service (block 210). The authentication step includes the borrower providing sufficient information for the trusted verification service to access the borrower's employment and income records from a payroll provider. This includes any login credentials, the identity of the payroll provider, and any other information required to login and accesses the employment and income records of the borrower, which typically would include at least a user name and password. The borrower also provides any necessary consent required by law or by the terms of the payroll provider.

The verification service then accesses employment and income information from the payroll provider (block 215). The verification service then generates and delivers verified employment and income data and/or a verified payroll document to a lender. The information may be provided to the lender with a certification of authenticity and be provided in a tamper proof document.

FIG. 2B illustrates a sequence of actions between a borrower, a lender, an employment and income verification vendor, and a payroll provider, showing in more detail an exemplary sequence of actions. A borrower 230 submits a loan application to a lender 240. In this example, the lender requests the trusted verification service 250 to provide verified payroll document information. In one embodiment the trusted verification service 250 operates as a third party vendor. For example, the third party vendor may operate as a web-based service providing services to the lending industry.

The trusted verification service 250, in turn, provides a web-page for the borrower 230 to input information sufficient to contact the payroll provider and access the borrower's employment and income records. The trusted verification service 250 then contacts the payroll provider 260 and receives, in return, a copy of an electronic payroll document of the borrower.

The trusted verification service then has several different options. First, it can provide a verified payroll document in a tamper proof form to the lender. Secondly, if desired, summary information may be generated and provided to the lender.

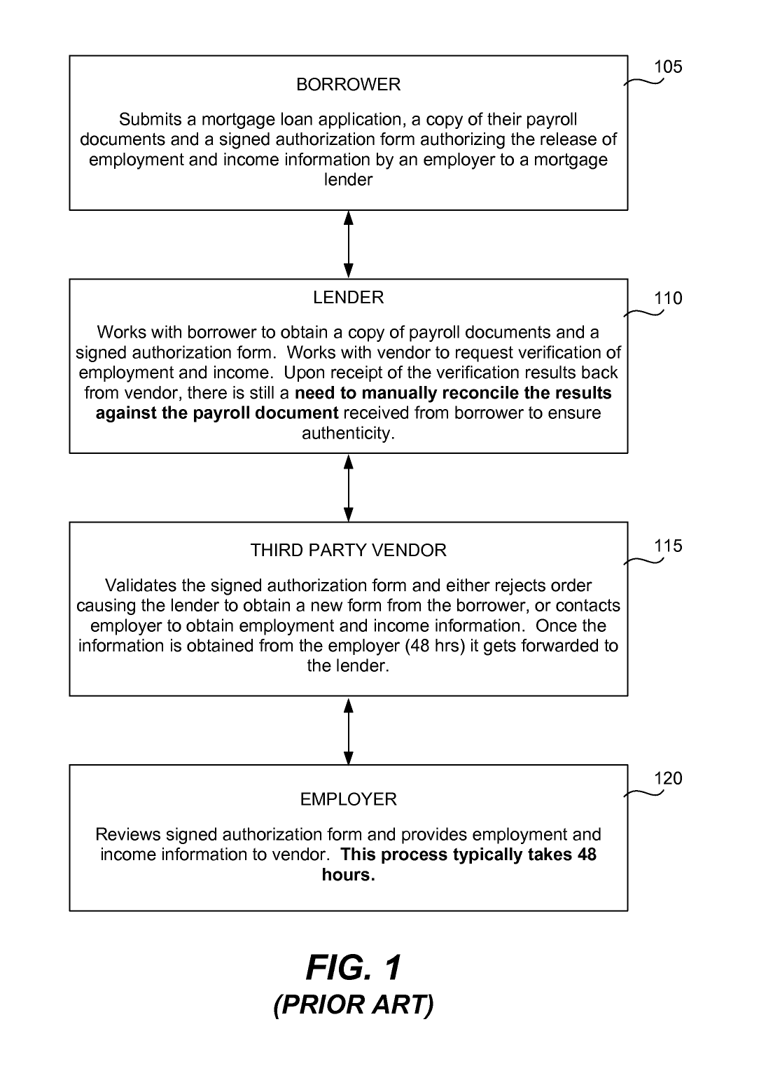

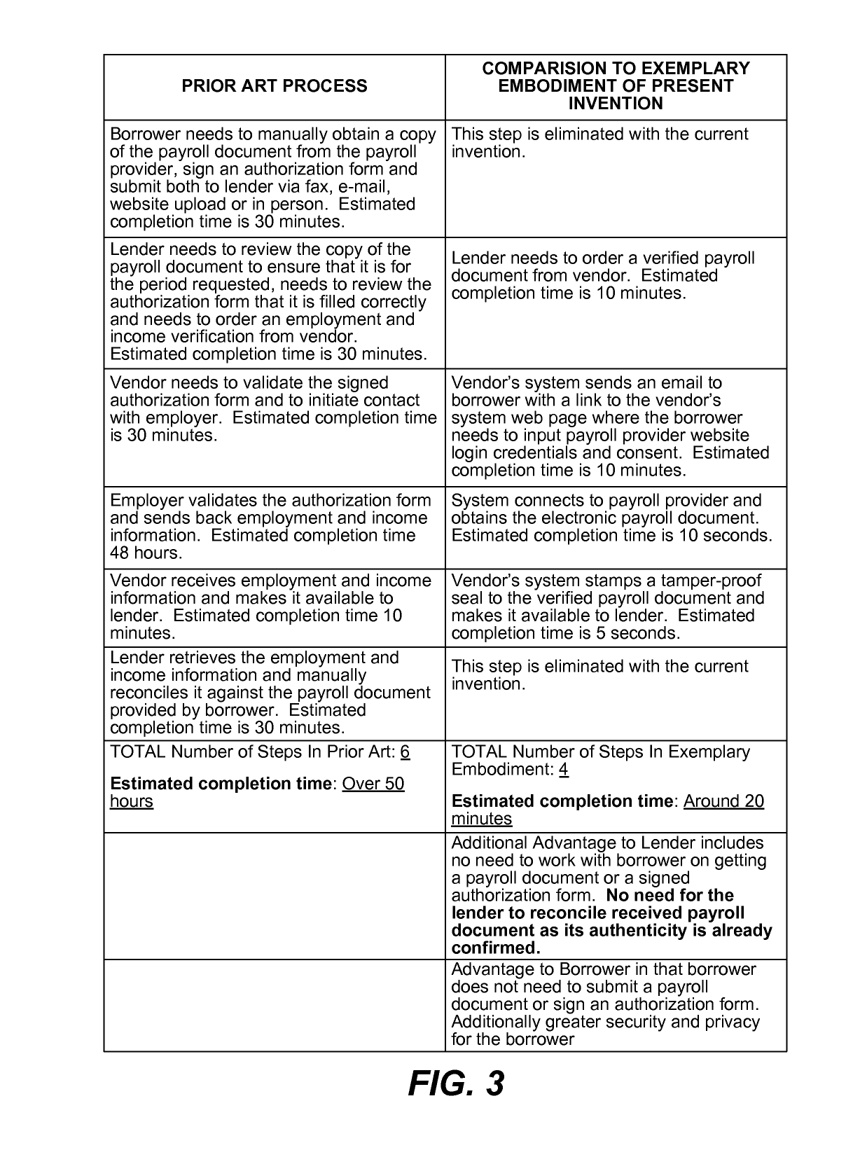

FIG. 3 illustrates a comparison of the method of FIG. 2B with the prior art method of FIG. 1. The estimated completion time for the prior art method is over 50 hours. In contrast, the estimated completion time for the method of FIG. 2B can be as little as 20 minutes or better, depending on factors such as Internet speed and access time at a payroll provider. Thus, the present invention provides a dramatic improvement and saves time and effort, making the loan application process easier and more efficient.

The advantage to both the borrower and the lender are substantial given the nature of the mortgage loan industry. Borrowers are often in a rush to search for a house, and saving several days of time to obtain a loan can provide a huge benefit. Additionally, both the borrower and the lender benefit from the improved efficiency of the system. Additionally, legitimate borrowers benefit from improved convenience and privacy protection.

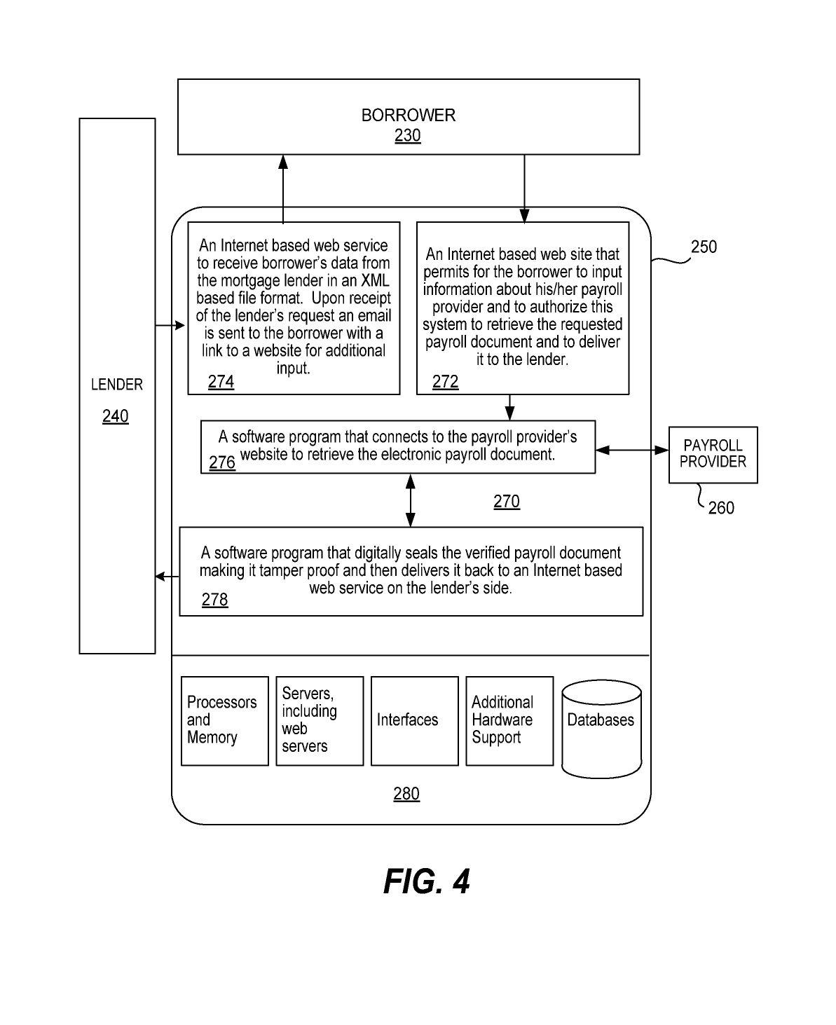

FIG. 4 illustrates an exemplary system to provide a trusted verification service 250 in accordance with an embodiment of the present invention. The system may be implemented as a computer system that includes both hardware and software components, such as a computer system, having one or more servers, computer processors, memory, and databases, with software modules stored on a computer readable medium. For the purposes of illustration, the trusted verification service 250 is conceptually divided into a hardware/support section 280 and a software system 270 for retrieving and delivery of a verified payroll document. The hardware/support section 280 includes processors, memory, servers, interfaces, databases, and any additional hardware support.

The software system 270 of FIG. 4 includes an exemplary set of software modules and services for the purposes of illustration, although it will be understood that variations on what is illustrated are within the scope of the present invention. The software modules are stored on a non-transitory computer readable medium and execute on the hardware/support section 280.

In one embodiment a software module 272 receives information about the borrower sufficient to access the borrower's employment and income information from a payroll provider. This may include names, dates of birth, social security number, payroll provider information and user account login credentials. Additionally, it could include equivalent information, such as employee ID information. Moreover, it may include whatever consent information or consent forms are required by a payroll provider and any relevant state, local, and national privacy and consent laws to authorize the payroll provider to provide the borrower's employment and income information to an employment and income verification service. The software module 272 could be implemented in several forms depending on the needs of the software system user. An exemplary embodiment includes an Internet based web service that receives the data and any additional information and/or documents in an XML format (or other format that can be processed); an Internet based web page that provides a forum for a user to input the necessary data and to upload any applicable documents; and any other software interface that allows the system to receive the data and any additional information and/or documents either as a manual user input or in a specific file format.

In one embodiment a software module 274 processes the data and sends an email to the borrower with a link to a website where the borrower can provide his/hers payroll provider account login information and an authorization to allow the system to retrieve an electronic payroll document from the payroll provider. This module 274, including email and a website, is only necessary if the login information and authorization requested from the borrower have not been provided by other means.

In one embodiment a software module 276 connects to the payroll provider to retrieve the payroll document. This module 276 could be implemented in several forms depending on the available functionality of the payroll provider's software systems, including:
1) A request to an Internet based web service that is made available by the payroll provider. Such request can be in an XML file format or any other file format as requested by the payroll provider and it can include information about the borrower and the requested payroll document as well as any additional information and/or documents requested by the payroll provider. The payroll provider can return the payroll document in a PDF file format, or any other file format as determined by the payroll provider. The payroll document file can be returned either in its raw form or it could be encapsulated in an XML file format, or any other file format as determined by the payroll provider. The payroll document could be returned synchronously, meaning that the web service made available by the payroll provider will respond to the initial request made by the system as part of the same session, or asynchronously, meaning that the response by the web service will be part of a different session. An asynchronous response may be triggered by the payroll provider as a push to a web service listening on the end of the module described herein, or it could be in a response in a subsequent request to the payroll provider's web service that inquires about the status of the initial request.
2) A software program that will act as a web browser on behalf of the borrower. Such program will automate the tasks of connecting to the payroll provider website, login in to that website as the borrower, navigating through the website links and pages, and retrieving the payroll document in the format made available by the payroll provider on the website.
3) Any other means provided by the payroll provider to connect and retrieve the payroll document.

In one embodiment a software module 278 packages and delivers the verified payroll document to the interested party. In one embodiment, additional security measures are employed to prevent tampering. In one embodiment, this module will place a digital tamper-proof stamp on the payroll document and will make it available to the interested party by means specified by that party. For example, a tamper-proof stamp or security code could be placed on a PDF file of the verified payroll document. The module 278 is optional and it could be implemented in a variety of ways as deemed necessary by the interesting party.

### USE EXAMPLES AND ALTERNATE EMBODIMENTS FOR THE INVENTION TO AUTHENTICATE PAYROLL DOCUMENTS, VALIDATE EXISTING PAYROLL DOCUMENT, AND AUTHENTICATE EMPLOYMENT AND INCOME

It will be understood that the functionality of the invention may be implemented in different ways. In particular, it will be understood that different parties may implement features of the present invention. As examples, the functionality may be implemented by a third party vendor, by a payroll provider, and also integrated with a lender's service.

### Use Example 1

Referring to FIG. 4, in this example, a third party vendor provides the trusted verification service and delivers authenticated payroll documents for lenders or other interested parties by getting a copy of these documents directly from payroll providers.

A mortgage lender is required to obtain a payroll document from a loan applicant and to validate the authenticity of that document for fraud prevention. To do so, they send an order to a third party vendor and provide basic information about the loan applicant, including names, social security number and email address. Upon receiving the order, the third party vendor sends an email to the loan applicant with a link to an Internet web page. On the web page, the loan applicant specifies what payroll provider is used to access the payroll document and inputs the login credentials for his/hers online account with that payroll provider. The loan applicant also checks a box to authorize the third party vendor to obtain a copy of the payroll document and to forward it to the mortgage lender. Upon receiving the information from the loan applicant, the third party vendor's system automatically connects to the payroll provider's website by using the loan applicant's login credentials and it retrieves a copy of the payroll document. The system then seals the verified copy of the payroll document, making it tamper-proof, and forwards it to the mortgage lender. Although processing times may vary depending on network conditions and other factors, the process can complete as fast as a few seconds once the loan applicant has provided login credentials and consent. There is no need for the loan applicant to manually pull the payroll document and to forward it to the lender, and no need for the lender to reconcile the payroll document as its authenticity is guaranteed by the method by which it was obtained.

### Additional Use Example 2

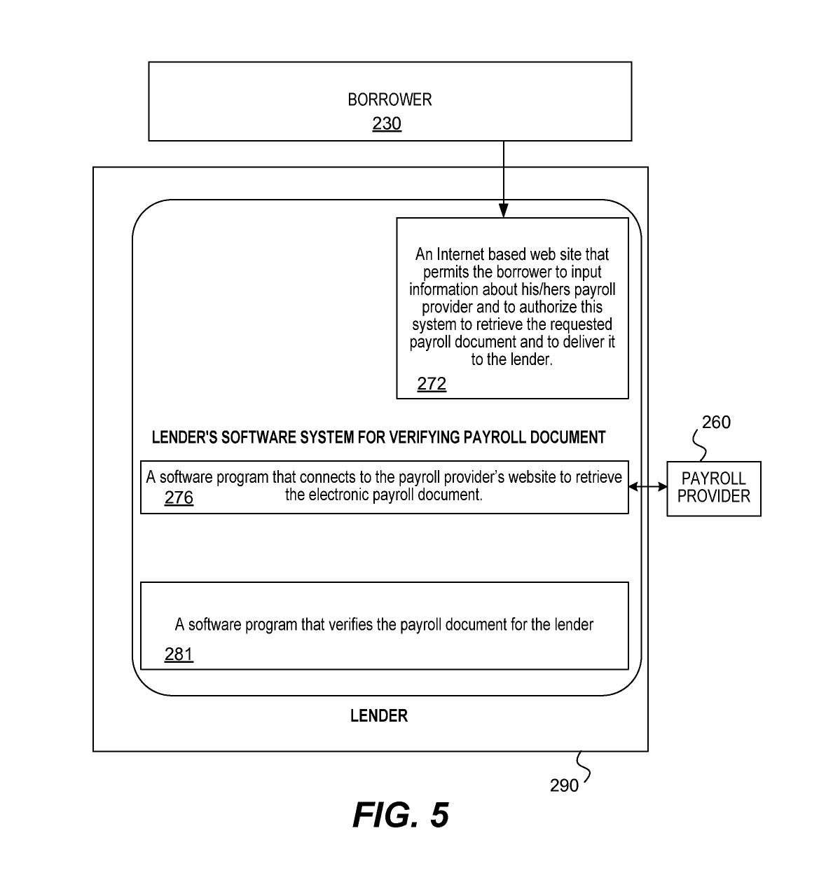

It will be understood that a large lender could also implement the verification service. As such, the lender would implement most of the modules of FIG. 4, with minor modifications, such as a software program 281 that verifies the payroll document for the lender. Depending on implementation, some features, such creating a tamper-proof copy, may be less important due to the fact that the lender is implementing the service. FIG. 5 illustrates an example set of software modules that a lender could implement to provide the service for themselves (hardware omitted for clarity). Referring to FIG. 5, in this example, a lender or an interested party gets an authenticated payroll document directly from a payroll provider. A mortgage lender can decide not to use a third party vendor to obtain a verified payroll document as outlined in the typical use example above. In that scenario, the mortgage lender implements a system to obtain login credentials from the loan applicant and to connect to the payroll provider's website in order to obtain the payroll document.

### Additional Use Example 3

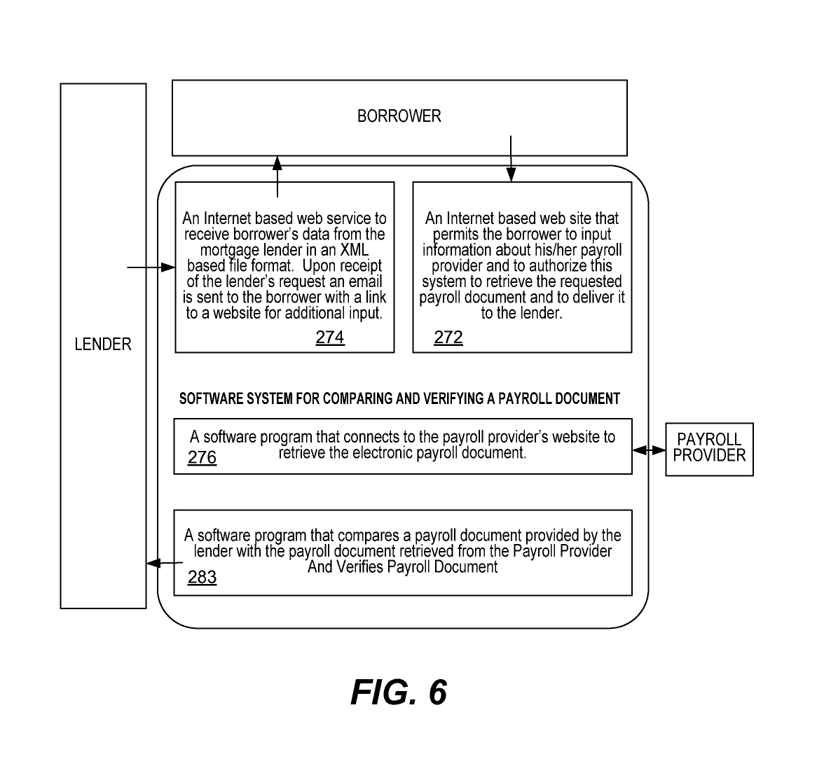

Referring to FIG. 6, in this example, a third party vendor offers a service to authenticate a payroll document provided by a lender or an interested party by comparing it against a payroll document retrieved from a payroll provider. In this example, the method is used to retrieve the payroll document from the payroll provider, but the return is only used for comparison and it is not being delivered to the lender. Instead of delivering a verified payroll document, as outlined in the typical use example above, a third party vendor may offer a service to validate an existing copy of the payroll document. In that scenario, the mortgage lender sends a copy of the payroll document along with the rest of the information. The vendor implements a system to obtain the login credentials from the loan applicant and to connect to the payroll provider's website to obtain the verified payroll document. The vendor then reconciles the mortgage lender's copy of the payroll document against the verified copy of the payroll document and reports its findings to the mortgage lender. Module 283 supports comparing the payroll document received from the lender with that obtained from the payroll provider.

### Additional Use Example 4

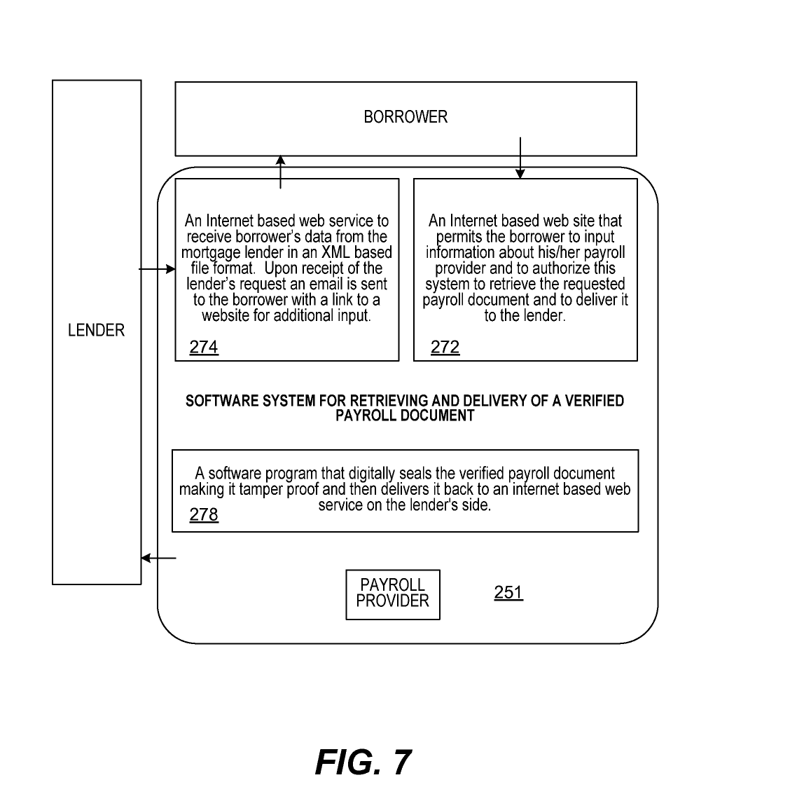

In one embodiment a payroll provider implements the trusted verification service. Referring to FIG. 7, in this example a payroll provider 251 offers a service to lenders and interested parties to provide them with an authenticated payroll document.

### Alternate Embodiments to Re-Check Employment and Income Information

In a typical use scenario the payroll document information is verified once. However, it will be understood that once the verification service has performed an initial verification that the process may be repeated, if desired, during the loan process. For example, in many home buying scenarios a borrower is initially qualified and the lender provides a guarantee for a range of loan amounts. The borrower then goes about searching for a home and on closing negotiations on the home, after which the house goes through escrow and closing. The entire process might take many weeks and thus extend over a payroll date. Additionally, in some situations the borrower's employment information may change during the home-hunting process. Thus, if desired, the user's consent to re-verify the employment and income information may be requested and the verification service would then perform a second employment and income verification step.

### Additional Alternate Embodiments of the Invention to Generate a Verified Summary of a Subset of Employment and Income Information

It will also be understood that individual fields of a payroll document may also be verified to generate a verified summary, such as those particular fields relevant to a lender or to others interested in the financial resources of an applicant.

Additionally, the employment and income information may be processed and provided to the lender in the form of employment and income checks and alerts.

For example, a mortgage lender may desire to receive a verified summary of the most relevant information related to the ability to payback a loan. The summary could be in addition to the complete verified payroll document or as an alternative.

Alternatively, it will be understood that the summary may be provided in areas outside of traditional home mortgage lending, such as a summary for obtaining other types of loans or as evidence of credit worthiness in other contexts, such as rentals.

### Additional Security and Privacy Implementation Examples

It will be understood that state-of-the art web security technology is preferably used. An exemplary system, implemented in 2013, includes services hosted at a Statement of Auditing Standards (SAS) 70 type II Certified facility. Web communications and data transmissions may be implemented with as Secure Socket Layer (SSL) based communications utilizing 128 bit encryption or better. More generally, the data security and privacy implementation may be implemented in accordance with the recommendations and requirements of government agencies and any relevant industry associations.

In one embodiment, a certificate of authenticity and an action log is provided to the lender. The certificate of authenticity provides an additional measure of trust to a lender. The certificate of authenticity, if used, is implemented to demonstrate that the employment and income information is coming from the trusted verification service. The certificate may be implemented, for example, using the approaches taken in ecommerce and finance areas to verify links, websites, and sources of products. As examples, the certificate may take the form of a digital certificate or digital signature; alternatively it may take the form of a digital watermark or a visual code.

From the perspective of the lender, proving the employment and income information in a tamper-proof form is a measure that aids in preventing fraud. While examples of tamper-proofing have been described, it will be understood that the employment and income information may be provided using other tamper-proofing techniques that may be developed in the future.

As previously discussed, the verification services requires connecting with the company that provides payroll services for the borrower's employer (the Payroll Provider). This, in turn, requires the service to access the borrower's online account with that company. In one embodiment the verification services requests the user name, password and any other login information that the borrower has setup up with that company to enable access.

Borrowers may have privacy concerns about providing their login credentials, given the large amounts of private information associated with their payroll documents. Thus, it is desirable to provide privacy protections measures for the borrower while also facilitating ease of use for the borrower.

The login credentials are used to download payroll documents and other information used in providing the verification services. Additionally, the login credential may be required for additional time periods to address errors or service interruptions in the download process. Storing the borrower's login credentials may be performed on a temporary basis to deal with issues such as service interruptions and error issues. However, it may also be useful to store the login credentials to make it easier for the borrower to reapply for a loan at a later time, or for other reasons.

A privacy protection protocol is preferably implemented. A retention policy defining how long and under what privacy protection conditions the login credentials are stored may be implemented. The borrower is preferably informed about the privacy protection policy.

If the verification service stores the borrower's login credentials, it preferably maintains and encrypts them on firewall-protected servers. This login information is encrypted and transmitted using secure socket layer technology, making it unreadable during transmission. It is then stored on secure servers.

Additional techniques may be employed to authenticate to the borrower that the user interfaces are secure. That is, the borrower may be provided with an indication or indicators to verify that the user interface is not a spamming attempt by a malicious party. In the case of the link/user interface being triggered in response to a request from a lender, information about the lender, a loan application ID, or other information may be provided. Any technique utilized in ecommerce and online finance to indicate that a site or a link is a trusted site/link may also be utilized to aid a borrower in understanding that the link/user interface is genuine and not a spamming attempt. Consequently, it will be understood that the process flows may be varied from those describe above to include additional security and/or assurance to the borrower that the user interface is genuine and that the borrower's confidential information will be given a high level of privacy protection.

While the convenience of the borrower is an important consideration, there may be a subset of borrowers that prefer to directly login to the trusted verification service rather than use a link sent to them. Additionally, a borrower could pre-register with a trusted verification service prior to applying for a loan. It will thus be understood that such variations are within the scope of embodiments of the present invention.

### Additional Borrower Convenience and Protection Examples

The verification service provides advantages to the borrower in terms of privacy protection and also convenience. It will be understood that it is contemplated that convenience and protection to the borrower may be extended in additional ways to those previously described.

There are an increasing number of individuals that are employed at two or more different jobs. For example, a borrower may be employed as a consultant or part-time employee at two different jobs. Thus, it will be understood that it is contemplated that the service may include provisions to permit the verification service to check with each of the different payroll providers associated with different employers of a borrower. In this example, the borrower would be requested to provide access information for the payroll providers of each of the borrower's employers.

Additionally, a lender may desire to check payroll information over an extended time period to verify that a borrower is not a default risk. If a borrower has switched jobs, the service may include provisions to check with each of the different payroll providers over some time period required by the lender. As an example, suppose that the lender wants to verify payroll information for the last two years. In this case the verification service may request the borrower to provide access information for each of the borrower's employers for the last two years.

Individual payroll providers may maintain employee records for different lengths of time. In theory a payroll provider could maintain records during the employee's entire length of service. Thus payroll records of payroll providers may include records going back in time for many years and/or have information not typically required in the lending process. For example, in theory a payroll provider might maintain records going back many years. Additionally, the online records maintained by the payroll provider might also contain more information than conventional paystubs or other forms of employment information used in the past by mortgage lender.

Typically, a lender legitimately needs to confirm employment and income to a degree necessary to verify that a borrower is not a default risk. This may include records demonstrating where a borrower works, a minimum number of years they have worked, and income information. However, it is possible that the payroll records could include additional information not required by the lender due to the length of time the records are maintained and/or additional information. As examples, if a payroll provider maintains “deep” payroll information for many years, it is possible that such information could include information, on an employee being fired and rehired in the distant past, information on time periods in the distant past when the employee was out on medical leave, etc. Some borrowers may be reluctant to disclose online payroll information that implicitly contains such confidential information. The verification service may, in some embodiments, implement a data filtering policy to filter out from review any extraneous confidential information not required in the lending process as an additional form of privacy protection for a borrower.

One issue that may be of concern in the future is that payroll providers are providing additional options to integrate payroll services with other different human resource services. For example, ADP's online payroll service offers the ability to track paid time off use and accrual. More generally, payroll providers, in some cases, offer options to integrate payroll services with benefits and human resource information.

Some employers even integrate payroll services with confidential personal information of the employee, For example, a community college in New Hampshire has implemented a version of ADP's payroll service that links the payroll information with personal information of the employee, such as phone numbers, emergency contacts, and even the race, ethnicity, and military service of the employee. (See e.g., the online guide published by the Community College of New Hampshire on how to use the ADP self-service iPay portal). It can thus be expected that online payroll services will, in some cases, integrate a wide variety of employment information with payroll information, including vacation, sick leave, medical leave, administrative leave, benefits, beneficiaries, and even highly sensitive personal information. It will thus be understood that some borrowers might balk at providing access to such personal information without being provided a privacy protection policy to filter out sensitive information not relevant for a lender to make a lending decision.

It will thus be understood that a privacy protection policy may be included to protect sensitive confidential information that is integrated with the payroll information that goes beyond the legitimate needs of a borrower. The privacy protection policy may also be implemented to prevent a lender discovering confidential information contrary to a government or industry policy.

It will thus be understood from these examples that a benefit of the present invention is that it may provide trusted filtering of the online payroll records to protect the borrower's privacy needs while also making it extremely convenient for a borrower to provide the information that is necessary for the lender to make a lending decision.

### Additional Embodiments Including Tax Income Information Verification

The present invention provides a technique to obtain employment and income information for making mortgage lending decisions. A technique to obtain tax information of a borrower is described in parent application U.S. patent application Ser. No. 14/103,455, which is incorporated by reference. It will be understood that the approach described in U.S. patent application Ser. No. 14/103,455 may be used in combination with the technique described in the present invention. First, it will be understood that a service may provide both types of information, e.g., both payroll and tax information. Second, it will also be understood that in some embodiments the two types of information may be compared by the service as an additional anti-fraud measure such as by noting any discrepancies between the payroll information and the tax information of the borrower.

### ADDITIONAL EMBODIMENTS

While the invention has been described in conjunction with specific embodiments, it will be understood that it is not intended to limit the invention to the described embodiments. On the contrary, it is intended to cover alternatives, modifications, and equivalents as may be included within the spirit and scope of the invention as defined by the appended claims. The present invention may be practiced without some or all of these specific details. In addition, well known features may not have been described in detail to avoid unnecessarily obscuring the invention.

As previously discussed, the software modules to implement the above-described processes may be implemented on a variety of different computer systems. In accordance with the present invention, the components, process steps, and/or data structures may be implemented using various types of operating systems, programming languages, computing platforms, computer programs, and/or general purpose machines. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein. The methods of the present invention may also be tangibly embodied as a set of computer instructions stored on a computer readable medium, such as a memory device.

What is claimed is:

1. A computer implemented method for a lender to obtain employment and income information for making a mortgage lending decision without requiring the borrower to provide payroll documents, comprising:
receiving, by a computer system, a request from a lender to obtain employment and income information for a borrower;
providing, by the computer system, a secure user interface for the borrower to enter information;
receiving, at the computer system, authentication information from the borrower, including information about the payroll provider used by the borrower to access payroll documents and access information, in the form of one or more of: login credentials used by the borrower to access their account with the payroll provider, consent to allow the payroll provider to release the payroll document to the interested party, and an interface or access protocol of the payroll provider to release the payroll document to the interested party;
securely storing, by the computer system, the received authentication information in an encrypted format on a secure server according to a privacy protection protocol in order to protect the privacy of confidential information of the borrower;
obtaining, by the computer system, a copy of the electronic payroll document from the payroll provider using the access information; and
generating, by the computer system, verified employment and income information for the borrower including:
securely transmitting to the lender, by the computer system, tamper-proof verified employment and income information of the borrower, including at least one of verified employment and income data and a verified payroll document; and
providing a certificate of authenticity to the lender.

2. A computer implemented method for obtaining payroll document information for making a lending decision without requiring a borrower to provide payroll documents, comprising the steps of:
receiving, at a server computer, authentication information from the borrower, the authentication information including information to obtain payroll document information from a payroll provider;
obtaining, by the server computer, the payroll document information from the payroll provider;
generating, at the server computer, verified employment and income information from the payroll document information of the borrower; and
providing, by the server computer, the verified employment and income information to a lender.

3. The computer implemented method of claim 1, wherein the verified income information includes at least one of a verified copy of the borrower's payroll document and a summary of the borrower's employment and income.

4. The computer implemented method of claim 2, further comprising converting the verified employment and income information in a tamper-proof form and providing the tamper-proof form to the lender.

5. The computer implemented method of claim 1, further comprising receiving a request from the lender for verified employment and income information and in response providing a user interface for the borrower to input the authentication information.

6. The computer implemented method of claim 1, wherein the authentication information includes the borrower's name, social security number, and the payroll provider used by the borrower to access payroll documents.

7. The computer implemented method of claim 1, wherein the authentication information includes login credentials of the borrower to access their account with the payroll provider.

8. The computer implemented method of claim 1, wherein the authentication information includes the consent of the borrower.

9. The computer implemented method of claim 1, wherein the borrower has provided a written consent to release payroll document information to the lender.

10. The computer implemented method of claim 2, wherein the method is performed by a third party vendor.

11. The computer implemented method of claim 2, wherein the method is performed by the lender.

12. The computer implemented method of claim 2, wherein the method is performed by an agent of a payroll provider.

13. A system for providing verified employment and income information to a lender without requiring a borrower to provide payroll documents, comprising:
a server computer including at least one processor, a memory, and having secure interfaces and firewall protection for communicating with a borrower, a lender, and a payroll provider;
the system including computer program code residing on the memory to:
receive, at a server computer, authentication information from the borrower, the authentication information including information to obtain payroll document information from the borrower's payroll provider;
obtain, by the server computer, the payroll document information from the borrower's payroll provider;
generate, at the server computer, verified employment and income information from the payroll document information of the borrower; and
provide, by the server computer, the verified employment and income information to a lender.

14. The system of claim 13, wherein the verified employment and income information includes at least one of a verified copy of the borrower's payroll document and a summary of the borrower's employment and income.

15. The system of claim 13, wherein the server computer provides the verified employment and income information in a tamper-proof form to the lender.

16. The system of claim 15, wherein the server computer provide a certificate of authenticity to the lender.

17. The system of claim 13, wherein the authentication information from the borrower is securely stored according to a privacy protection protocol in order to preserve privacy of the authentication information.

18. The system of claim 13, wherein the server computer receives a request from the lender for verified employment and income information and in response providing a user interface for the borrower to input the authentication information.

19. The system of claim 13, wherein the authentication information includes the borrower's name, social security number, and the payroll provider used by the borrower to access payroll documents.

20. The system of claim 13, wherein the authentication information includes login credentials of the borrower to access their account with the payroll provider.

21. The system of claim 13, wherein the authentication information includes the consent of the borrower.

22. The system of claim 13, wherein the system receives a request from the lender and in response sends a user interface link to the borrower for the borrower to enter the authentication information.
